(19) United States
(12) Patent Application Publication
(10) Pub. No.: US 2023/0364947 A1
(43) Pub. Date: Nov. 16, 2023

(54) NON-PNEUMATIC TIRE HAVING REINFORCED SUPPORT STRUCTURE AND METHOD OF MAKING SAME

(71) Applicant: Bridgestone Americas Tire Operations, LLC, Nashville, TN (US)

(72) Inventors: Andrew R. Tupta, Massillon, OH (US); Benjamin E. Rimai, Copley, OH (US); Christopher W. Burton, Stow, OH (US)

(21) Appl. No.: 18/029,300

(22) PCT Filed: Sep. 9, 2021
(86) PCT No.: PCT/US21/71398

§ 371 Date: Mar. 29, 2023

Related U.S. Application Data
(60) Provisional application No. 63/090,859, filed on Oct. 13, 2020.

(51) Int. Cl. B60C 7/14

(52) U.S. Cl. CPC B60C 7/146

(57) ABSTRACT

A non-pneumatic tire includes an inner ring, an outer ring, and a support structure extending between the inner ring and the outer ring. The support structure has a reinforcement layer disposed therein, where the reinforcement layer has cords containing multiple filaments or strands of filaments, and the cord satisfies the following relationship: x*y<18,000, where x is the stiffness of cord measured in Megapascals, and y is the diameter of the largest filament in the cord measured in mm. The reinforcement layer may contain cords having a Lang Lay construction.

### FIELD OF INVENTION

The present disclosure relates to a non-pneumatic tire having support structure containing a reinforcement layer and a method of making the same.

### BACKGROUND

Various tire constructions have been developed which enable a tire to run in an uninflated or underinflated condition. Non-pneumatic tires do not require inflation, while “run flat tires” may continue to operate after receiving a puncture and a complete or partial loss of pressurized air, for extended periods of time and at relatively high speeds. Non-pneumatic tires may include a plurality of spokes, a webbing, or other support structure that connects an inner ring to an outer ring.

### SUMMARY OF THE INVENTION

In one embodiment, a non-pneumatic tire includes an inner ring having a first diameter and an outer ring having a second diameter greater than the first diameter. The outer ring is substantially coaxial with the inner ring. The tire further includes support structure extending between the inner ring and the outer ring. The support structure includes at least one layer of reinforcement. The layer of reinforcement comprises one or more cords containing multiple filaments or strands of filaments, and the cord satisfies the following relationship:

x*y<18,000
where x is the stiffness of cord measured in Megapascals, and
y is the diameter of the largest filament in the cord measured in mm.

In another embodiment, a non-pneumatic tire includes an inner ring having a first diameter and an outer ring having a second diameter greater than the first diameter. The outer ring is substantially coaxial with the inner ring. The tire further includes support structure extending between the inner ring and the outer ring. The support structure includes a plurality of loops extending laterally from a first side of the non-pneumatic tire to second side of the non-pneumatic tire. Each of the plurality of loops defines an opening that is visible from the first side of the non-pneumatic tire. Each of the plurality of loops is in direct contact with both the inner ring and the outer ring. The plurality of loops includes at least a first loop and a second loop, the first loop being in direct contact with the second loop. At least one of the plurality of loops contains at least one layer of reinforcement. The layer of reinforcement comprises one or more cords containing multiple filaments or strands of filaments, and the cord satisfies the following relationship:

x*y<18,000
where x is the stiffness of cord measured in Megapascals, and
y is the diameter of the largest filament in the cord measured in mm.

In yet another embodiment, a non-pneumatic tire includes an inner ring having a first diameter and an outer ring having a second diameter greater than the first diameter. The outer ring is substantially coaxial with the inner ring. The tire further includes support structure extending between the inner ring and the outer ring. The support structure includes a plurality of spokes having a first spoke end and a second spoke end. Each of the plurality of spokes follows a path that is offset from being perfectly straight between the first spoke end and the second spoke end. Each of the plurality of spokes contains at least one layer of reinforcement. The layer of reinforcement comprises one or more cords containing multiple filaments or strands of filaments, and the cord satisfies the following relationship:

x*y<18,000
where x is the stiffness of cord measured in Megapascals, and
y is the diameter of the largest filament in the cord measured in mm.

### BRIEF DESCRIPTION OF DRAWINGS

In the accompanying drawings, structures are illustrated that, together with the detailed description provided below, describe exemplary embodiments of the claimed invention. Like elements are identified with the same reference numerals. It should be understood that elements shown as a single component may be replaced with multiple components, and elements shown as multiple components may be replaced with a single component. The drawings are not to scale, and the proportion of certain elements may be exaggerated for the purpose of illustration.

FIG. 1 is a front view of one embodiment of a non-pneumatic tire;

FIG. 2 is an enlarged partial front view of the non-pneumatic tire of FIG. 1;

FIG. 3 is a schematic drawing illustrating a partial front view of a non-pneumatic tire during its construction;

FIG. 4 is a front view of an alternative embodiment of a non-pneumatic tire;

FIG. 5 is a perspective view of another alternative embodiment of a non-pneumatic tire;

FIG. 6 illustrates a close-up front view of the non-pneumatic tire of FIG. 5;

FIG. 7a is a partial front view of a Right Lang Lay cord construction;

FIG. 7b is a partial front view of a Left Lang Lay cord construction; and

FIG. 8 is a cross-sectional view of one embodiment of a cord construction.

### DETAILED DESCRIPTION

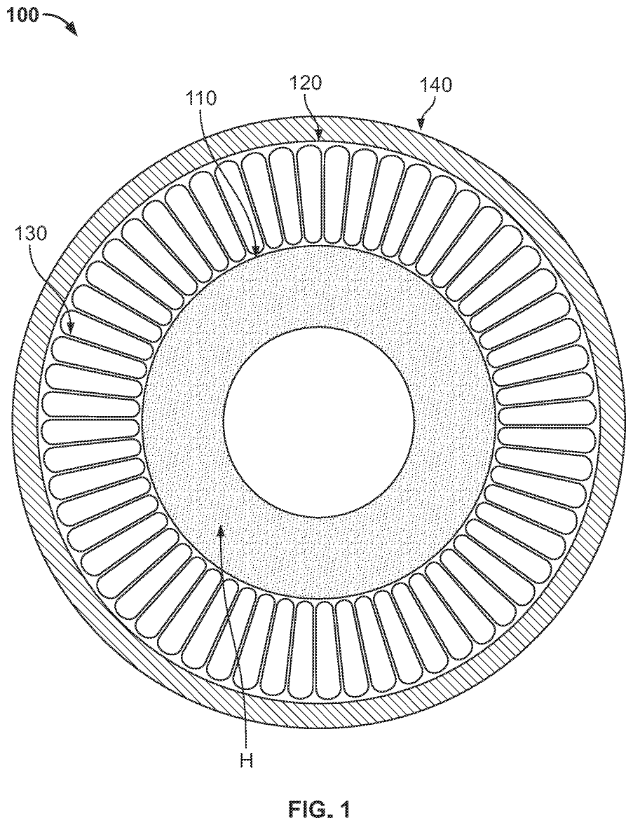

FIG. 1 is a front view of one embodiment of a non-pneumatic tire 100. The non-pneumatic tire 100 includes an inner ring 110 having a first diameter, and an outer ring 120 having a second diameter greater than the first diameter. The outer ring 120 is substantially coaxial with the inner ring 110. In the illustrated embodiment, the inner ring 110 is shown as being attached to a hub H. A plurality of spokes 130 extend between the inner ring 110 and the outer ring 120. In an alternative embodiment, a webbing or other support structure may be employed instead of spokes. It should be understood that the term “support structure” may refer to either webbing or spokes.

A circumferential tread 140 is disposed about the outer ring 120 in the illustrated embodiment. The tread 140 may include tread elements such as grooves, ribs, blocks, lugs, sipes, studs, and other elements. A shear band or other shear element or reinforcement structure (not shown) may be disposed between the outer ring 120 and the tread 140. In an alternative embodiment (not shown), the separate tread may be omitted and instead tread elements may be formed directly on the outer ring.

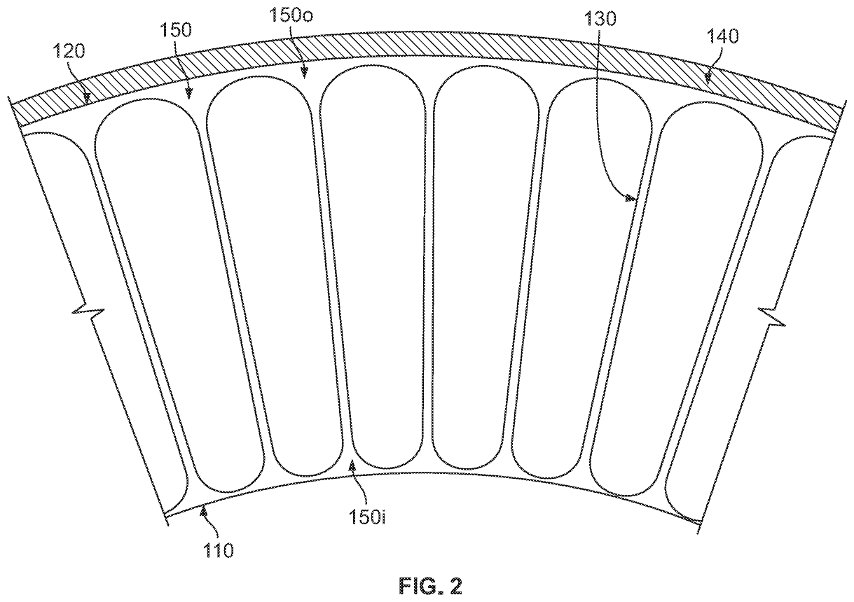

FIG. 2 is an enlarged partial front view of the non-pneumatic tire of FIG. 1. As can be seen in this view, the spokes 130 are formed by a plurality of loops disposed in a series circumferentially about the tire. Each of the individual loops extends laterally from a first side of the non-pneumatic tire 100 to second side of the non-pneumatic tire 100. Each of the plurality of loops defines an opening that is visible from the first side of the tire.

In the illustrated embodiment, each of the plurality of loops is in direct contact with both the inner ring 110 and the outer ring 120. A plurality of fillets 150 are also disposed between the inner ring 110 and the outer ring 120. The plurality of fillets 150 includes inner fillets 150i and outer fillets 150o. The inner fillets 150i are in direct contact with the inner ring 110, and both a first loop and a second loop in each adjacent pair of loops. The outer fillets 150o are in direct contact with the outer ring 120, and both the first loop and second loop in each adjacent pair of loops.

The inner and outer rings 110, 120 may be constructed of a polymeric material, such as natural or synthetic rubber, or other elastomeric material. Alternatively, the inner and outer rings 110, 120 may be constructed of a harder polymeric material such as polyurethane, polyester, nylon, or polyvinyl chloride (PVC). The spokes 130 are formed of loops that may be constructed of elastomeric material having a single layer of reinforcement disposed therein. The loops may be constructed from a sheet of elastomeric material, or from a spiraled ribbon of elastomeric material having a single layer of reinforcement disposed therein. Where the loop is formed by a sheet, the ends of the sheet may be butt spliced together. The splice may be located at the inner ring or outer ring of the non-pneumatic tire. Where the loop is formed by a spiraled ribbon, the butt splice may be omitted.

In both instances, the reinforcement may be steel cords. In other embodiments, the reinforcement may be formed by cords constructed of nylon, polyester, fiber glass, carbon fiber, aramid, glass, polyethylene (polyethylene terephthalate), or other reinforcement materials. In an alternative embodiment, the loops may be constructed of elastomeric material having two or more layers of reinforcements.

In one embodiment, the layer of reinforcement includes one or more cords containing multiple filaments or strands of filaments, and the cord satisfies the following relationship:

x*y<18,000
where x is the stiffness of cord measured in Megapascals, and
y is the diameter of the largest filament in the cord measured in mm.

To determine the stiffness of the cord discussed in this disclosure and any embodiment herein, the cord is subjected to tensile strength testing according to ASTM D-2969 using a gauge length of 660 mm. The stress is calculated by dividing the load on the cord (N) by the cross-sectional area of the cord (mm²). The cross-sectional area of the cord is the sum of the real cross-sectional area of the individual filaments in the cord, not the area obtained by circumscribing a circle around the entire cord. The stress value (MPa) for a given strain (mm/mm) is plotted up to the point of cord breakage and the whole curve is fitted with a linear trend line. The slope of the trend line represents the stiffness of the cord.

It has been found that to improve fatigue performance of the reinforcement layer; it is desirable to use a cord having relatively low stiffness in combination with a cord having a relatively small diameter. In one embodiment, the cord may have a stiffness of less than 90,000 MPa. In another embodiment, the cord may have a stiffness of less than 70,000 MPa, and in yet another embodiment the stiffness may be less than 50,000 MPa. In one embodiment, the diameter of the largest filament in the cord may be 0.2 mm or less. In another embodiment, the diameter of the largest filament in the cord may have a diameter of less than 0.19 mm, and in yet another embodiment a diameter of less than 0.18 mm.

In one embodiment, the cords have a Lang Lay construction. A Lang Lay construction is one in which the filaments that make up the strands are laid in a helical pattern and twisted in the same direction that the strands are laid and twisted to make up the cord. The Lang Lay construction provides improved fatigue resistance, which is beneficial for the support structure of the non-pneumatic tire.

If the loops have more than one layer of reinforcement, at least one layer has cords satisfying the following relationship:

x*y<18,000
where x is the stiffness of cord measured in Megapascals, and
y is the diameter of the largest filament in the cord measured in mm.

In other embodiments that have multiple layers of reinforcement, more than one layer, or alternatively all layers, may have cords that satisfy the following relationship:

x*y<18,000
where x is the stiffness of cord measured in Megapascals, and
y is the diameter of the largest filament in the cord measured in mm.

Likewise, if the loops have more than one layer of reinforcement, in one embodiment, one layer may have cords having a Lang Lay construction. In alternative embodiments, more than one layer may have cords having a Lang Lay construction. In other alternative embodiments, all layers of reinforcement may have cords having a Lang Lay construction.

The tread 140 and the fillets 150 may both be constructed of an elastomeric material, such as natural or synthetic rubber, other elastomeric material.

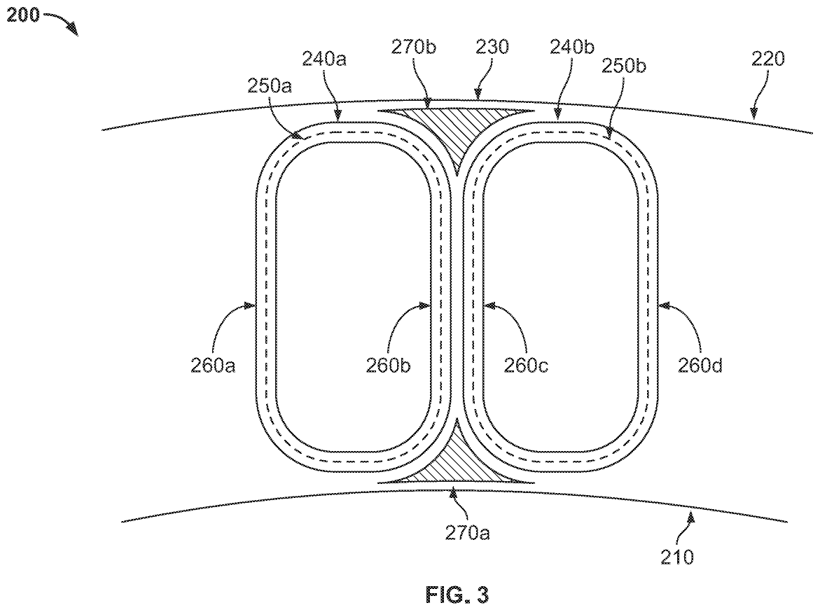

Additional details of the loops of the non-pneumatic tire shown in FIG. 1 and FIG. 2 may be seen in FIG. 3, which is a schematic drawing illustrating a partial front view of a non-pneumatic tire 200 during its construction. The non-pneumatic tire 200 includes an inner ring 210 having a first diameter, and an outer ring 220 having a second diameter greater than the first diameter. The outer ring 220 is substantially coaxial with the inner ring 210. As shown in this figure, a spoke 230 is being formed by a first loop 240a and a second loop 240b. The first loop includes a first layer of reinforcement cords 250a, and the first loop forms a first substantially radial extent 260a and a second substantially radial extent 260b. The second loop includes a second layer of reinforcement cords 250b, and the second loop forms a third substantially radial extent 260c and a fourth substantially radial extent 260d.

Additionally, a first fillet 270a is disposed between the first loop 240a, the second loop 240b, and the inner ring 210. A second fillet 270b is likewise disposed between the first loop 240a, the second loop 240b, and the outer ring 220.

At the stage shown in FIG. 3, the first loop 240a is spaced from the second loop 240b. This spacing may be exaggerated for illustrative purposes. During the process of forming the non-pneumatic tire, heat and pressure are applied during a curing process. Specifically, pressure is applied to the second extent 260b of the first loop 240a and to the third extent 260c of the second loop 240b, which causes the second extent 260b to contact the third extent 260c. As heat and pressure are applied, the second extent 260b bonds with the third extent 260c, such that the first loop 240a and the second loop 240b form a single spoke 230 having two layers of reinforcement cords formed by the first and second layer of reinforcement cords 250a,b. The resulting spoke 230 extends in a substantially radial direction, in the same manner as the spokes 130 of FIGS. 1 and 2.

In one embodiment, at least half of the second extent 260b is in contact with at least half of the third extent 260c. In an alternative embodiment, at least two-thirds of the second extent 260b is in contact with at least two-thirds of the third extent 260c.

In the illustrated embodiment, each of the first and second layers of reinforcement cords 250a,b extends in a substantially radial direction in the resulting spoke 130. In an alternative embodiment, one or both of the layers of reinforcement cords is biased with respect to the radial direction. In one such embodiment, one or both of the layers of reinforcement cords is biased at an angle between 500 and 90°. In such an embodiment, a butt splice may also be angled.

In an alternative embodiment, the extents between the inner and outer ring are curved rather than linear. Curved extents may be used to control the direction and the magnitude of spoke buckling as the tire rotates. Such curved extents may still be considered substantially radial. In one such embodiment, the reinforcement cords may have the same curve as the extents. In an alternative embodiment, the reinforcement cords may have different curves from the extents. In another alternative embodiment, the reinforcement cords may extend linearly while the extents are curved.

In other alternative embodiments, the extents are substantially linear while one or more of the layers of reinforcement cords are curved with respect to radial direction. Curved layers of reinforcement cords may be used to control the direction and the magnitude of spoke buckling as the tire rotates. In such embodiments, the resulting spoke may still extend linearly when in an uncompressed state, even though one or more of the layers of reinforcement cords are curved. In such an arrangement, the spokes may be described as having a reinforcement pre-curvature.

To build a non-pneumatic tire, such as the non-pneumatic tire 100 or 200, an operator may perform the steps of providing an inner ring of elastomeric material, providing an outer ring of elastomeric material, and arranging the inner ring and the outer ring such that the inner ring is substantially coaxial with the outer ring. In one embodiment, the operator provides sheets of reinforced elastomeric material, and forms a plurality of loops with the sheets of reinforced elastomeric material. The elastomeric material is reinforced with cords that satisfy the following relationship:

x*y<18,000
where x is the stiffness of cord measured in Megapascals, and
y is the diameter of the largest filament in the cord measured in mm.

The cords may have a Lang Lay construction. Each loop may be formed by butt splicing the ends of the sheet together. The operator then places the loops of reinforced elastomeric material between the inner ring and the outer ring. The loops may be arranged such that the butt splice is tangential to either the inner ring of the outer ring.

In another embodiment, the operator provides a ribbon of reinforced elastomeric material. In one particular embodiment, the operator forms a ribbon by extruding a ribbon of green rubber with exactly two steel cords, thus forming a green rubber ribbon with two steel cords embedded therein.

In yet another embodiment, the operator forms a ribbon by extruding a ribbon of green rubber with one steel cord. In still another embodiment, the operator forms a ribbon by extruding a ribbon of green rubber with three or more steel cords.

In an alternative embodiment, the ribbons may be made by a calendering operation rather than an extruding operation. For example, in one embodiment, the ribbons are made by calendering rubber over cords and the slitting the calendered sheet into thin ribbons containing one, two, or more cords.

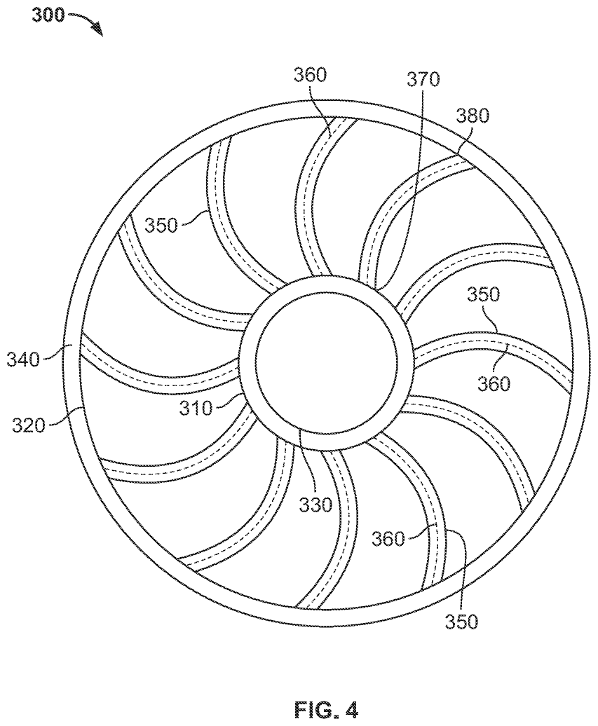

FIG. 4 shows an alternative embodiment of a non-pneumatic tire 300. The non-pneumatic tire 300 includes an inner ring 310 having a first diameter, and an outer ring 320 having a second diameter greater than the first diameter. The outer ring 320 is substantially coaxial with the inner ring 310. In the illustrated embodiment, the inner ring 310 is shown as being attached to a hub 330.

A circumferential tread 340 is disposed about the outer ring 320. The tread 340 may include tread elements such as grooves, ribs, blocks, lugs, sipes, studs, and other elements. A shear band or other shear element or reinforcement structure (not shown) may be disposed between the outer ring 320 and the tread 340. In an alternative embodiment, the separate tread may be omitted and instead tread elements may be formed directly on the upper ring.

In the illustrated embodiment, a plurality of individual spokes 350 extend between the inner ring 310 and the outer ring 320. In this embodiment, the design of each one of the plurality of spokes 350 is substantially identical. However, in an alternative embodiment, the plurality of spokes may include spokes having different designs.

The spokes 350 each have a first spoke end 370 and a second spoke end 380, and follow a path that is offset from being perfectly straight between the first spoke end 370 and a second spoke end 380.

The inner and outer rings 310, 320 may be constructed of a polymeric material, such as natural or synthetic rubber, or other elastomeric material. Alternatively, the inner and outer rings 310, 320 may be constructed of a harder polymeric material such as polyurethane, polyester, nylon, or polyvinyl chloride (PVC). The spokes 350 may be constructed of elastomeric material having a single layer of reinforcement 360 disposed therein. More specifically, the spokes 350 may be constructed from a sheet of elastomeric material having a single layer of reinforcement 360 disposed therein.

The reinforcement may be steel cords. In other embodiments, the reinforcement may be formed by cords constructed of nylon, polyester, fiber glass, carbon fiber, aramid, glass, polyethylene (polyethylene terephthalate), or other reinforcement materials. In an alternative embodiment (not shown), the spokes may be constructed of elastomeric material having two or more layers of reinforcements.

The layer of reinforcement contains cords that satisfy the following relationship:

x*y<18,000
where x is the stiffness of cord measured in Megapascals, and
y is the diameter of the largest filament in the cord measured in mm.

In one embodiment, the cord may have a stiffness of less than 90,000 MPa. In another embodiment, the cord may have a stiffness of less than 70,000 MPa, and in yet another embodiment the stiffness may be less than 50,000 MPa. In one embodiment, the diameter of the largest filament in the cord may be 0.2 mm or less. In another embodiment, the diameter of the largest filament in the cord may have a diameter of less than 0.19 mm, and in yet another embodiment a diameter of less than 0.18 mm. In one embodiment, the cords have a Lang Lay construction.

If the spokes have more than one layer of reinforcement, at least one layer has cords that satisfy the following relationship:

x*y<18,000
where x is the stiffness of cord measured in Megapascals, and
y is the diameter of the largest filament in the cord measured in mm.

In other embodiments that have multiple layers of reinforcement, more than one layer, or alternatively all layers, may have cords that satisfy the following relationship:

x*y<18,000
where x is the stiffness of cord measured in Megapascals, and
y is the diameter of the largest filament in the cord measured in mm.

Likewise, if the spokes have more than one layer of reinforcement, in one embodiment, one layer may have cords having a Lang Lay construction. In alternative embodiments, more than one layer may have cords having a Lang Lay construction. In other alternative embodiments, all layers of reinforcement may have cords having a Lang Lay construction.

The tread 340 may be constructed of an elastomeric material, such as natural or synthetic rubber, other elastomeric material.

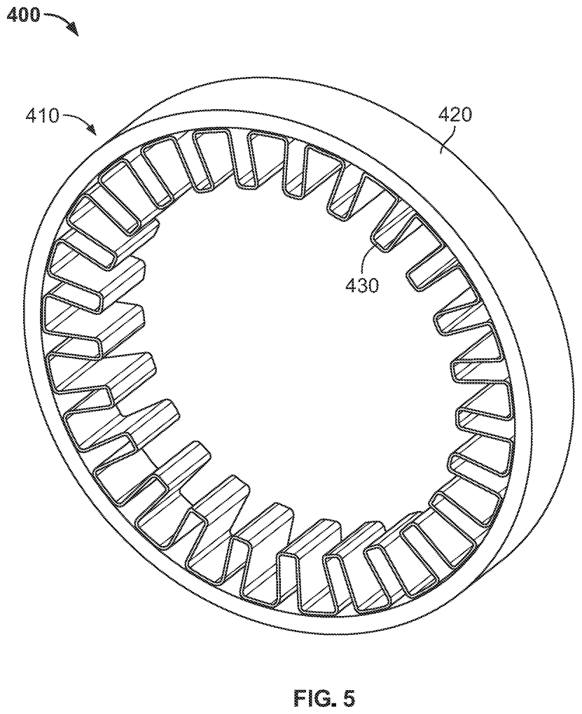

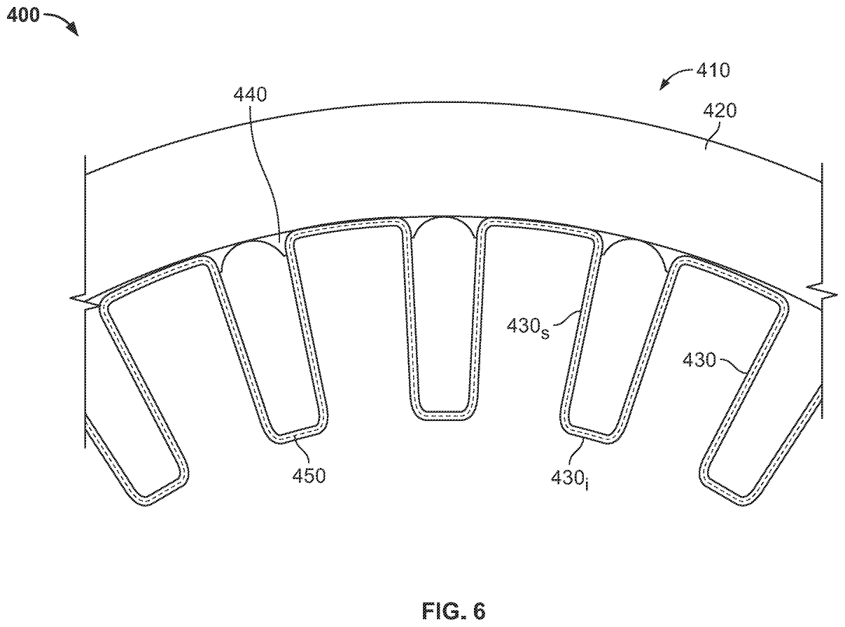

FIG. 5 shows another alternative embodiment of a non-pneumatic tire 400, while FIG. 6 shows a close-up front view of the non-pneumatic tire 400 shown in FIG. 5. The non-pneumatic tire 400 includes an outer ring 410. The outer ring 410 may be constructed of a rubber ply 420. Alternatively, the outer ring 410 may be constructed of a material other than rubber. In alternative embodiments, the outer ring is formed by a ply constructed of a foamed polymer, polyurethane, thermoplastics, resins, or other elastomeric or polymeric material. In another alternative embodiment, the ply is constructed of metal instead of a polymeric material. In another alternative embodiment, the outer ring 410 is a solid hoop.

The tire 400 further includes a plurality of loops 430 extending inward from the outer hoop 410. In the illustrated embodiment, the loops 430 are formed by a serpentine spoke ply disposed continuously about the central axis of the tire 400 such that a longitudinal axis of the serpentine spoke ply is substantially parallel to the equatorial plane of the tire 400. The serpentine spoke ply follows a winding path between an inner diameter and an outer diameter, such that the serpentine spoke path has a plurality of inner portions 430ᵢ that extend in a substantially circumferential direction about the inner diameter. The serpentine spoke path further has a plurality of outer portions 430ₒ that extend in a substantially circumferential direction about the outer diameter. A plurality of spoke portions 430ₛ extend in a substantially radial direction between the inner diameter and the outer diameter.

In the illustrated embodiment, all of the inner portions 430ᵢ have substantially the same arc length. Likewise, each outer portion 430ₒ also has substantially the same arc length, with the arc length of the outer portions 430ₒ being greater than the arc length of the inner portions 430ᵢ. In one embodiment, a total arc length of the inner portions 430ᵢ is between 120 degrees and 240 degrees. A total arc length of the outer portions 430ₒ is also between 120 degrees and 240 degrees. In one embodiment, a sum of the total arc length of the inner portions 430ᵢ and the total arc length of the outer portions 430ₒ is 360 degrees. In an alternative embodiment, a sum of the total arc length of the inner portions and the total arc length of the outer portions is less than 360 degrees. In another alternative embodiment, a sum of the total arc length of the inner portions and the total arc length of the outer portions is greater than 360 degrees.

In an alternative embodiment, different inner portions may have different arc lengths. Likewise, different outer portions may also have different arc lengths.

In the illustrated embodiment, the loops 430 are constructed of a ply having a width equal to a width of the tire 400. In an alternative embodiment, the loops are constructed of a ply that is narrower than the tire. In such an embodiment, the ply may be biased with respect to the equatorial plane of the tire. In one such embodiment, each of the spoke portions of the serpentine spoke ply extends at an angle of less than 45 degrees with respect to the radial direction. Likewise, each of the inner portions of the serpentine spoke ply extends at an angle of less than 45 degrees with respect to the equatorial plane and each of the outer portions of the serpentine spoke ply extend at an angle of less than 45 degrees with respect to the equatorial plane.

The loops 430 may be constructed of elastomeric material having a single layer of reinforcement 450 disposed therein. The reinforcement may be steel cords. In other embodiments, the reinforcement may be formed by cords constructed of nylon, polyester, fiber glass, carbon fiber, aramid, glass, polyethylene (polyethylene terephthalate), or other reinforcement materials. In an alternative embodiment, the loops may be constructed of elastomeric material having two or more layers of reinforcements.

The layer of reinforcement 450 contains cords that satisfy the following relationship:

x*y<18,000
where x is the stiffness of cord measured in Megapascals, and
y is the diameter of the largest filament in the cord measured in mm.

In one embodiment, the cord may have a stiffness of less than 90,000 MPa. In another embodiment, the cord may have a stiffness of less than 70,000 MPa, and in yet another embodiment the stiffness may be less than 50,000 MPa. In one embodiment, the diameter of the largest filament in the cord may be 0.2 mm or less. In another embodiment, the diameter of the largest filament in the cord may have a diameter of less than 0.19 mm, and in yet another embodiment a diameter of less than 0.18 mm. In one embodiment, the cords have a Lang Lay construction.

If the loops have more than one layer of reinforcement, at least one layer has cords that satisfy the following relationship:

x*y<18,000
where x is the stiffness of cord measured in Megapascals, and
y is the diameter of the largest filament in the cord measured in mm.

In other embodiments that have multiple layers of reinforcement, more than one layer, or alternatively all layers, may have cords that satisfy the following relationship:

x*y<18,000
where x is the stiffness of cord measured in Megapascals, and
y is the diameter of the largest filament in the cord measured in mm.

Likewise, if the loops have more than one layer of reinforcement, in one embodiment, one layer may have cords having a Lang Lay construction. In alternative embodiments, more than one layer may have cords having a Lang Lay construction. In other alternative embodiments, all layers of reinforcement may have cords having a Lang Lay construction.

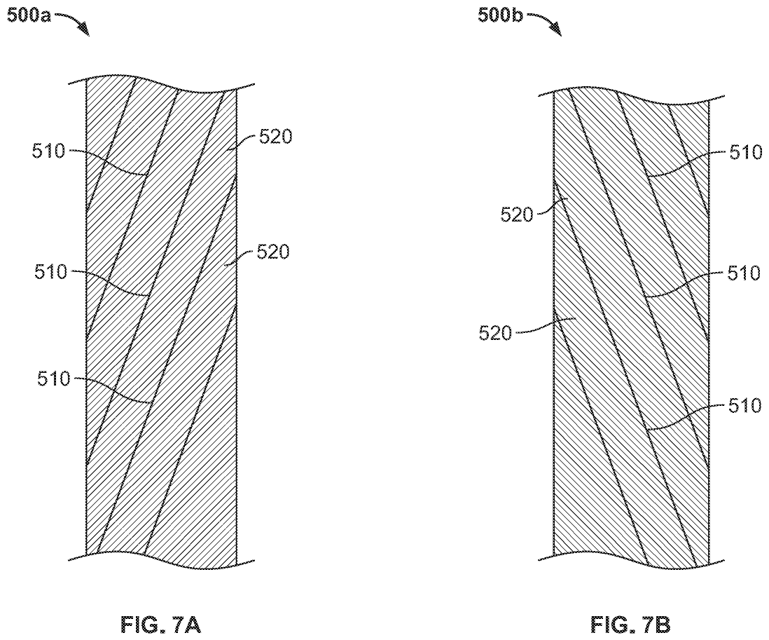

FIG. 7a is a partial front view of a cord having a Right Lang Lay construction, and FIG. 7b is a partial view of a cord having a Left Lang Lay construction. It can be seen that the lay of strands 510 is in the same direction as the lay of filaments 520.

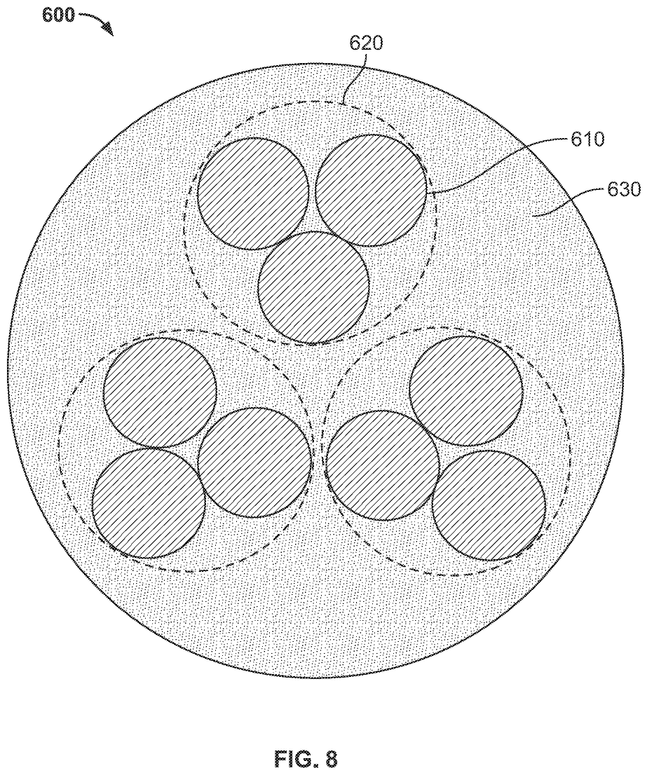

FIG. 8 is sectional view of an exemplary cord construction that can be used in the reinforcement layer of any of the embodiments discussed herein. In the example shown, cord 600 is 3×3 cord, meaning three filaments 610 are wound to make a strand 620, and three strands 620 are wound to make the cord 600. The cord 600 is coated with an elastomeric material 630. In one particular embodiment, the cord is a steel cord having a 3×3×0.17 Lang Lay construction, meaning three filaments are wound to make a strand, three strands are wound to make a cord, and each of the filaments have a diameter of 0.17 mm.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan Garner, A Dictionary of Modern Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or components.

While the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the application, in its broader aspects, is not limited to the specific details, the representative apparatus and method, and illustrative examples shown and described. Accordingly, departures may be made from such details without departing from the spirit or scope of the applicant's general inventive concept.

What is claimed is:

1. A method of making a non-pneumatic tire, the method comprising:
providing an inner ring having a first diameter;
providing an outer ring having a second diameter greater than the first diameter, the outer ring being substantially coaxial with the inner ring;
extending a support structure between the inner ring and the outer ring,
wherein the support structure includes a layer of reinforcement disposed therein, and said layer of reinforcement comprises one or more cords containing multiple filaments or strands of filaments, said cord satisfying the following relationship:
x*y<18,000
where x is the stiffness of cord measured in Megapascals, and
y is the diameter of the largest filament in the cord measured in mm.

2. The method of claim 1, wherein the cords are steel cords.

3. The method of claim 1, further comprising twisting the cords in a Lang Lay construction.

4. The method of claim 3, further comprising twisting the cords comprise in a 3×3×0.17 mm construction.

5. The method of claim 2, further comprising forming the support structure of elastomeric material.

6. A non-pneumatic tire comprising:
an inner ring having a first diameter;
an outer ring having a second diameter greater than the first diameter, the outer ring being substantially coaxial with the inner ring;
a support structure extending between the inner ring and the outer ring, wherein the support structure includes a layer of reinforcement disposed therein, and said layer of reinforcement comprises one or more cords containing multiple filaments or strands of filaments, said cord satisfying the following relationship:
x*y<18,000
where x is the stiffness of cord measured in Megapascals, and
y is the diameter of the largest filament in the cord measured in mm.

7. The non-pneumatic tire of claim 6, wherein the cords are steel cords.

8. The non-pneumatic tire of claim 6, wherein the cords have a Lang Lay construction.

9. The non-pneumatic tire of claim 8, wherein the cords comprise a construction of 3×3×0.17 mm.

10. The non-pneumatic tire of claim 7, wherein the support structure comprises elastomeric material.

11. The non-pneumatic tire of claim 6, wherein the support structure includes a plurality of loops extending laterally from a first side of the non-pneumatic tire to second side of the non-pneumatic tire,
wherein each of the plurality of loops defines an opening that is visible from the first side of the non-pneumatic tire,
wherein each of the plurality of loops is in direct contact with both the inner ring and the outer ring, and
wherein the plurality of loops includes at least a first loop and a second loop, the first loop being in direct contact with the second loop.

12. The non-pneumatic tire of claim 11, wherein each of the plurality of loops is formed by a spiraled ribbon of elastomeric material having a single layer of reinforcement disposed therein, and said reinforcement comprises steel cords having a Langs Lay construction.

13. The non-pneumatic tire of claim 12, wherein the spiraled ribbon of elastomeric material includes exactly two steel cords embedded therein.

14. The non-pneumatic tire of claim 12, wherein the first loop includes a first extent and a second extent extending between the inner ring and the outer ring, wherein the second loop includes a third extent and a fourth extent extending between the inner ring and the outer ring, and wherein the second extent contacts the third extent.

15. The non-pneumatic tire of claim 14, wherein each of the first extent, the second extent, the third extent, and the fourth extent are curved.

16. A non-pneumatic tire comprising:
an inner ring having a first diameter;
an outer ring having a second diameter greater than the first diameter, the outer ring being substantially coaxial with the inner ring;
a support structure extending between the inner ring and the outer ring, the support structure including a plurality of spokes having a first spoke end and a second spoke end,
wherein each of plurality of spokes follows a path that is offset from a straight path between the first spoke end and the second spoke end;
wherein each of the plurality of spokes includes a layer of reinforcement disposed therein, and the layer of reinforcement includes one or more cords containing multiple filaments or strands of filaments, the cord satisfying the following relationship:
x*y<18,000
where x is the stiffness of cord measured in Megapascals, and
y is the diameter of the largest filament in the cord measured in mm.

17. The non-pneumatic tire of claim 16, wherein the cords are steel cords.

18. The non-pneumatic tire of claim 16, wherein the cords have a Lang Lay construction.

19. The non-pneumatic tire of claim 18, wherein the cords have a construction of 3×3×0.17 mm.

20. The non-pneumatic tire of claim 16, wherein the support structure includes elastomeric material.
